(19) United States
(12) Patent Application Publication
(10) Pub. No.: US 2009/0145861 A1
(43) Pub. Date: Jun. 11, 2009

(54) Centrifugal device comprising improved process analysis technology

(76) Inventor: Joachim Schmid, Wallhausen (DE)

Correspondence Address: Shlesinger Arkwright & Garvey, 1420 King Street, Suite 600, Alexandria, VA, 22314, US

(21) Appl. No.: 11/921,795

(22) PCT Filed: Jun. 9, 2006
(86) PCT No.: PCT/EP2006/005546

§ 371 Date: Dec. 7, 2007

(30) Foreign Application Priority Data
Jun. 15, 2005 (DE) 10 2005 028 832.4

(51) Int. Cl. B01D 21/30; B01D 21/26; B01D 21/32

(52) U.S. Cl. 210/781; 210/512.3; 210/85; 210/143; 210/95

(57) ABSTRACT

The invention relates to a centrifugal device comprising improved process analysis technology (PAT), to a method for measuring the moisture content of a suspension in a centrifugal drum and to a method for sampling from a centrifugal device. The centrifugal device is equipped with: a drive shaft; a drum that is connected to the drive shaft; a filter that is located inside the drum and that surrounds a working chamber; a baffle plate that forms a front face of the working chamber and that is mounted on a baffle plate shaft, the baffle plate and the drum being axially displaceable; a filler element for filling a working chamber with a suspension; and a centrifugal housing that surrounds the drum and the filter. In addition, various process analysis devices are provided, in particular tubes comprising monitoring and measuring units that are inserted into the working chamber and windows comprising associated channels that are configured n the baffle plate.

The present invention relates to a centrifuge device comprising improved process analysis technology (PAT), a method of measuring the moisture content of a suspension in a centrifuge drum and a method of taking samples from a centrifuge device. The term “centrifuge devices” in conjunction with the present invention refers to any embodiments of centrifuge devices. Within the scope of the present description reference is made in particular to centrifuge devices with an integrated dryer function, so-called centrifuge dryers. The present invention and the technical features disclosed therein may also be applied, however, to centrifuge devices without an integrated dryer and to all other kinds of centrifuges. The term centrifuge device is thus to be understood as not restricted to a particular type of centrifuge.

Centrifuge devices are known in a variety of applications in the field of industrial use. In the pharmaceutical industry, in particular, they play a major part in the manufacture of medicines. The known centrifuge devices share the common feature that in a suspension contained therein, i.e. a fluid with a solid component, the solid phase is to be separated from the liquid phase. In centrifuge devices with dryers the solid phase is additionally dried after the separation so as to produce a powder.

The separation of solid phase and liquid phase takes place by introducing the suspension into a drum through a filling means and then rotating this drum at high speed. It is also known to set the drum rotating first and then add the fluid during rotation, in order to avoid an imbalance caused by the introduction of the suspension at the start of the rotation process. During the rotation, strong centrifugal forces act on the suspension, causing the suspension to be pressed against the outer surface of the drum, uniformly distributed around the circumference.

A filter is provided on the outer surface of the drum. This may be a filter cloth, as in an inverted centrifuge, for example, or it may be a metal filter element. The use of a filter element means that the liquid phase of the suspension passes through the filter during centrifuging while the solid phase remains inside the drum.

The drum traditionally consists of an outer surface and a drum base which is integrally formed with the outer surface and forms an end face of the drum. The drum base is mounted on a drive shaft which is driven by a motor. A second end face of the drum is formed by a catchment disk which seals off the drum. The drum, i.e. the drum jacket and drum base, and the catchment disk are axially movable relative to one another so that the end product can be removed from the interior of the drum. The catchment disk is mounted on a catchment disk shaft. Generally, one of theshafts (i.e. the catchment disk shaft or drive shaft) is of hollow construction so as to form a channel through which the suspension can be introduced into the interior of the drum, even if the drum is already rotating.

Frequently, the filter is of conical construction, in which case an axial force also acts on the suspension during centrifuging, causing the centrifuged product to collect on one end face of the drum. This end face is usually the one formed by the catchment disk, as this end face is opened in order to take out the product. In addition, the product can be moved more easily towards the catchment disk end face during drying and removal of the product, as its movement is assisted by the conical shape.

After centrifuging, the wet solid phase of the suspension adheres to the interior of the drum jacket in a specific layer thickness. This adhering suspension is referred to as the cake. Various methods are known for removing this cake from the drum. They can generally be subdivided into pneumatic removal methods and mechanical removal methods.

The mechanical removal methods include on the one hand the method of a filter cloth consisting of an elastic filter material which is used in inverted centrifuges. This filter cloth has the shape of a cylinder jacket and is connected at one edge to the drum jacket and at the other edge to a second drum base which, when the drum is closed, is arranged directly on the inside of the first drum base. The second drum base is moreover connected to the catchment disk so as to move together with it. The catchment disk and the second drum base are then moved axially relative to the drum, while the filter cloth is so to speak “turned inside out”. The catchment disk and the second drum base have to be moved over twice the length of the drum until the entire filter cloth has been inverted. The inversion causes the cake to be detached from the filter cloth and the centrifuged product can be removed. A disadvantage of this design is that the catchment disk has to be moved twice the length of the drum and the entire centrifuge device therefore assumes substantial dimensions.

In another known mechanical method of removing the cake, asecond drum base connected to the catchment disk is again used. However, instead of a filter cloth, a metal filter is used which is arranged on the inside of the drum jacket. The second drum base has a diameter which is only slightly smaller than the diameter of the metal filter. For removal, the catchment disk and the second drum base are then moved axially relative to the drum with the metal filter, so that the second drum base pushes the cake out of the drum. An advantage of this arrangement is that the axial length of the centrifuge device as a whole is shorter, as the catchment disk and the second drum base only have to be moved along the distance of one drum length. A disadvantage is that the gap between the second drum base and the metal filter may become so large, as a result of manufacturing inaccuracies or wear, that residues of product in the drum adhere to the filter and remain there. Then even repeated movement of the second drum base has no chance of dislodging these residues of product and the filter remains clogged by these residues.

In pneumatic removal methods, a fluid, usually a gaseous fluid, is injected under high pressure into an intermediate space between the metal filter and the drum jacket, known as an annular space, and the cake is broken away from the filter in this way, to come to rest in the lower part of the drum. Owing to the fact that the filter has a cone which widens out to the catchment disk in this method, repeated surges of gaseous fluid may cause the product located on the base of the drum to be transported successively towards the catchment disk and transported out of the drum.

Moreover, each of the types of centrifuge devices mentioned above may also be equipped with a dryer function which allows the wet solid phase of the suspension to be dried after centrifuging. This is done, for example, in centrifuge devices with a pneumatic outlet by spraying a fluid gas into the interior of the drum so that the product contained in the drum gradually dries. Thus, after the drum has been opened, by movement of the catchment disk, a dried product can be removed in powder form and further processed immediately.

Conventionally, the final quality of the product obtained by centrifuging and drying is only checked after the entire process, i.e. after centrifuging and drying. In some cases quality examination is also carried out before and during the processing operation but as this takes some time, in the event that the quality check has negative results, the entire product obtained in the manufacturing process is no longer usable. For example, it may happen that the product removed is not yet quite dry. However, a damp product cannot be further processed in some cases and has to be disposed of. This results in wastage and far from insignificant economic damage.

Devices for checking the product quality and the state of the suspension during centrifuging or during drying are only inadequately implemented, and usually not implemented at all, in conventional centrifuge devices. The possibility of measuring product-specific parameters on-line, i.e. during the processes of filling, centrifuging, drying, cleaning, etc., would give an opportunity of ensuring the desired product quality and adjusting the individual process steps to an optimum level.

For example, after centrifuging, the suspension is frequently washed with a flushing fluid. The best time for this wash is when there is still some fluid phase remaining in the suspension. In previous centrifuge devices, it was virtually impossible to detect this time as the operator simply had to wait until no more liquid phase was flowing out of the interior. However, when the liquid phase has already finished flowing out, the problem arises that air bubbles have formed in the cake which prevent the flushing fluid from washing all the cake. With a device for monitoring the state of the suspension during centrifuging, however, the flushing process could be started at the optimum time, when there is still some liquid phase in the cake.

Correspondingly, there is a need for a process analysis technology which enables the product quality and the state of the suspension to be monitored during centrifuging and drying and the manufacturing process to be adapted as necessary. Thanks to the possibility thus created of controlling or regulating product-specific parameters on-line, it is possible to ensure.that in every case the product obtained is usable and no product has to be disposed of.

The technical features listed hereinafter for improving process analysis technology in centrifuge devices are intended particularly for those centrifuge devices which operate with a metal filter and a pneumatic outlet but can also be used in conjunction with any other possible embodiments of centrifuge devices.

For this purpose, a centrifuge device is proposed, having a drive shaft, a drum attached to the drive shaft, a filter arranged inside the drum and surrounding a working space, a catchment disk that forms one end face of the working space and is mounted on a catchment disk shaft, the catchment disk and the drum being movable relative to one another, with a fill element for introducing a suspension into the working space and with a centrifuge housing that surrounds the drum and the filter.

In a preferred embodiment of the invention, the drive shaft is hollow in construction and has a drive shaft channel extending therein, in which is accommodated a drive shaft fill tube which is used as a fill element for the introduction of a suspension. In another preferred embodiment of the invention, a funnel-shaped element is mounted on an end of the drive shaft fill tube in the working space. In one embodiment of the invention this funnel-shaped element isintegrally formed with the drive shaft fill tube.

In one embodiment of the invention the catchment disk shaft is of hollow construction and comprises a catchment disk shaft channel extending therein, in which a catchment disk fill tube is accommodated which is used as a fill element for the introduction of a suspension.

In one embodiment of the invention, a funnel-shaped element is mounted on an end of the drive shaft fill tube at the working space end.

In another embodiment of the invention this funnel-shaped element may be integrally formed with the catchment disk shaft fill tube. Thus, either the catchment disk shaft or the drive shaft is of hollow construction and a tube accommodated therein is used as a fill element for the introduction of a suspension.

In a preferred embodiment of the invention, the suspension that is to be centrifuged and dried is conveyed by means of a pumping device, the pressure exerted on the suspension by the pumping device being variable. The funnel-shaped element gives the advantage that the suspension does not drip downwards from the edge of the hollow shaft or trickle down the inside of the drum base in the direction of the drum base. By varying the pump pressure and using a funnelshaped element the suspension flows onto the filter at a variable spacing from the drum base. By varying the pressure it is possible to vary the point of impact of the suspension on the filter during introduction and the suspension can thus be uniformly distributed within the drum during the introduction process. In this way deposits on the drum base which would occur over the duration of continuous use, without a funnel-shaped element, are prevented and in this way the quality of the product produced is improved.

In a preferred embodiment of the invention the drive shaft is driven by an electric asynchronous motor. Preferably, the electric asynchronous motor is controlled by a movement control unit to which an transmitter unit sends the current position of the electric asynchronous motor, the drive shaft being rotatable in both directions of rotation by means of the electric asynchronous motor. Preferably, the transmitter unit is a sine/cosine transmitter.

Preferably, the electric asynchronous motor has a secondary shaft extending through it which is connected in each case via a force-transmitting endless element to both the drive shaft and to the transmitter unit. Thanks to the asynchronous motor arrangement described above it is possible to install the asynchronous motor away from the drive shaft, thus improving access to the asynchronous motor and thereby making maintenance and repair of the asynchronous motor easier. The other process analysis technologies described hereinafter place high demands on the accuracy of positioning of the drum. The combination of features described above ensures this high positional accuracy of the drum.

In a preferred embodiment of the invention the centrifugedevice comprises a reciprocating piston eccentrically mounted on the catchment disk for axially moving said catchment disk. Obviously, any other suitable mechanism or any other suitable device for axially moving the catchment disk may be used, such as a pneumatic device, for example.

Preferably, the catchment disk shaft is of hollow construction and comprises inside it a PAT (process analysis technology) channel one end of which opens into the working space.

In another embodiment of the invention the drive shaft is of hollow construction and comprises inside it a PAT channel one end of which opens into the working space. In the preferred embodiment of the invention in which the drive shaft is used as a fill element for the introduction of a suspension, the catchment disk shaft is accordingly of hollow construction and comprises a PAT channel inside it.

As described hereinbefore, it would naturally also be possible to use the channel in the catchment disk shaft for introducing a suspension, and to use a channel formed in a hollow drive shaft as a PAT channel. An eccentric arrangement of the reciprocating pistons on the catchment disk is needed whenever the catchment disk has to be moved. In one possible embodiment in which the catchment disk is stationary and the drum with the filter is moved axially, a device for axially moving the drum and the filter would have to be mounted correspondingly eccentrically.

The eccentric mounting of the reciprocating pistons on the catchment disk in the preferred embodiment makes it possible to construct the catchment disk shaft to be hollow and the resulting channel is accessible for further use. Within the scope of the present invention, this further use is primarily process analysis technology.

In a preferred embodiment of the invention, at least one tube is passed through the PAT channel and projects into the working space. In a preferred embodiment of the invention, the at least one tube is surrounded by a casing tube. If a plurality of tubes are to be provided, these are arranged together in the casing tube and the casing tube is passed through the PAT channel. The use of a casing tube makes it easier to arrange the tubes in the PAT channel, as the at least one tube and the optionally several tubes provided can be pre-assembled in the casing tube. Moreover, the use of a casing tube makes it easier to seal the PAT channel as a surface is formed which is easy to handle. The sealing of the at least one tube in the casing tube is also made easier as this assembly does not have to be carried out in the centrifuge device.

In one embodiment of the invention, the at least one tube is mounted so as to be uncoupled from any rotation of the catchment disk and catchment disk shaft. This is the case if the at least one tube is not surrounded by a casing tube. In a preferred embodiment the casing tube is mounted so that it can be uncoupled from a movement of the catchment disk and catchment disk shaft. Thus, the at least one tube mounted in the casing tube is disconnected from the rotation of the catchment disk or catchment disk shaft. The mounting described above has the result that the tubes passing through the PAT channel do not rotate with the disk. This is an important prerequisite for introducing some of the process analysis technologies described below into the working space and making effective use of them. This is the case particularly with optical equipment. Theoretically it is also possible for the tubes to rotate together with the drum, for example when an optical device is being used which is required to take photographs from the same point in the drum.

In one embodiment of the invention, in the at least one tube there is provided a device for carrying out infrared (NIR) spectroscopy. Such a device is used to measure the moisture content of the suspension.

In another embodiment of the invention, a device for measuring the temperature at the working space end of the at least one tube is provided in the tube.

In one embodiment of the invention, an optical monitoring unit is provided at the working space end of the at least one tube, for monitoring the working space. This optical monitoring unit may be a camera, for example.

In another embodiment of the invention, a light source for illuminating the working space is provided at the working space end of the at least one tube.

In another embodiment of the invention, an endoscope is passed through the at least one tube into the working space. The endoscope preferably comprises a combination of a light source and camera.

In another embodiment of the invention the at least one tube is constructed as a removal tube for removing a sample of suspension. In this case, an element for taking a sample of suspension is preferably mounted at the working space end of the at least one tube. The element for taking a sample of suspension is preferably a funnel. Moreover, a pump device is preferably provided which is capable, by virtue of a vacuum produced by it, of sucking up the sample of suspension through the at least one tube. Moreover, there is preferably an outlet opening in the centrifuge device through which the sample of suspension sucked out of the sample space through the at least one tube comes out. Using the arrangement described above, a sample of suspension which has entered the funnel can be sucked through the tube and taken out through an outlet opening. As a result, it is possible at any time to examine the suspension without interrupting the operation of the centrifuge or opening the working space.

Preferably, the pumping device is also capable of pumping a fluid which it has placed under pressure through the at least one tube. In this way it is possible to clean the tube using the fluid.

Preferably, a sealed housing element is arranged around the outlet opening. This may be a so-called glove box, for example. This is a box of transparent material in which two glove elements are incorporated in one of its walls, through which an operator can work with items contained in the glove box without coming into direct contact with the items. In this way it is possible to take samples of toxic suspensions without having to seal off the entire room in which the centrifuge device is located and without the workers having to wear protective suits.

In another embodiment of the invention an ultrasound cleaning device is arranged at the working space end of the at least one tube.

In a preferred embodiment the PAT channel is sealed off from the outer environment by means of a sealing element. This is particularly necessary when working with toxic suspensions or products. However, it is theoretically possible for the PAT channel to be sealed off both at its outer end in contact with the environment and at its working space end to prevent contamination of the channel and to increase the protection against the escape of toxic material from the working space into the outer atmosphere. Preferably, the sealing element is an antiseptic double lip seal.

In a preferred embodiment of the invention a rotary device is provided for rotating the at least one tube. It is possible both for the at least one tube to rotate in the casing tube and also for the tube to be fixed relative to the casing tube and to be rotated by the rotating device for the casing tube, so that the tube rotates with it. If more than one tube is provided, it is preferable that the tubes are fixed in the casing tube and the rotary device rotates the casing tube jointly with the tubes encased therein.

Preferably, the rotary device is constructed so that the at least one tube can be fixed in at least one position. This is to prevent the tube or the casing tube to which the tube is fixedly attached from undesirably moving out of its position.

Preferably, the at least one tube is adapted to be fixed by means of the rotating device in a first position, in a second position which is rotated through 90° from the first position, and in a third position which is rotated through 90° from the second position and through 180° from the first position.

Preferably the range of rotation of the rotary device is limited to 180° by two stops.

Preferably the rotary device is to be operated manually. In another embodiment the centrifuge device comprises a motor for causing rotation of the rotary device. In one embodiment the motor is automatically controlled by a control unit. In this way the rotation of the at least one tube can be automatically regulated and tied into the entire processing operation and its control.

In a preferred embodiment, three tubes are provided. Preferably, an endoscope with an optical monitoring unit and a light source is passed through a first tube. A second tube is designed to take a sample of suspension and comprises a funnel-shaped element at its working space end, and a third tube is provided with a device for measuring the temperature at its working space end.

Preferably the three tubes are arranged in the crosssection of the casing tube such that the centres of the tube cross-sections form a triangle.

Preferably, the first tube runs straight, i.e. in the direction of the drive shaft opposite, into the working space, the second tube is bent substantially at right angles in the working space and the funnel-shaped element is arranged at the working space end so that when the three tubes are in the process of rotating, as a result of the rotary device, from the first position into the third position, the funnel-shaped element performs a semicircular movement in a lower half of the working space, and the third tube in the first position points substantially perpendicularly downwards. In this way, the funnel can be moved in a semicircle through the suspension which is located at the bottom, manually or automatically, by a simple 180° rotation by means of the rotary device, so that a sample of suspension enters the funnel.

In a preferred embodiment of the invention, at least one window of transparent material is provided in the catchment disk. This makes it possible to see in from outside the working space and thus carry out monitoring using optical equipment. Preferably, at least one window channel is provided in the centrifuge device, one end of the window channel terminating in front of the at least one window. Through the window channel, optical equipment can be introduced from outside and moved up to the window provided in the catchment disk.

Preferably, a device for carrying out near infrared (NIR) spectroscopy is provided in the at least one window channel.

In one embodiment of the invention an optical monitoring device is provided in the at least one window channel. This may be a camera, for example.

In one embodiment of the invention, a light source is provided in the at least one window channel. This serves to illuminate the working space or the cake in front of the window which is being monitored by the optical monitoring device. However, the disadvantage may arise that the light source reflects in the window provided in the catchment disk and thus reduces the quality of the optical monitoring. For this reason it is preferable to illuminate the working space by means of a light source introduced into the working space through the PAT channel, which does not have this disadvantage. In conjunction with an optical monitoring device situated in the window channel this results in particularly effective monitoring of the cake.

In a preferred embodiment of the invention, three windows are provided which are arranged at 120° intervals around the circumference of the catchment disk. As the catchment disk rotates with the windows, an optical monitoring device or a device for NIR spectroscopy or some other device located in the window channel does not continuously monitor the working space. Rather, a picture is obtained made up of a number of individual images which are taken while a window in the catchment disk is moving past the window channel in question. The quality of the image taken or the measurement recorded depends on the frequency of the images, i.e. the number of images per second. The number of images per second is in turn a function of the speed of rotation and the number of windows distributed around the circumference. Accordingly, when three windows are provided, three pictures are taken during one rotation, so that the picture frequency is three times as great. This results in a substantially improved picture quality.

In one embodiment of the invention, three window channels are provided which are arranged at 120° intervals around the circumference of the catchment disk. Under certain circumstances, the NIR spectroscopy device or the optical monitoring device may take up all the space in a window channel, so that a plurality of window channels are needed to accommodate all the desired apparatus. On the other hand, the entire working space can be monitored through the catchment disk with three cameras offset by 120°.

The method according to the invention for measuring the moisture content of a suspension in a centrifuge drum comprises the steps of preparing a centrifuge device according to the main claim of the present invention which also comprises reciprocating pistons eccentrically mounted on the catchment disk for axially moving the catchment disk, the catchment disk shaft being hollow in construction and comprising within it a PAT channel, one end of which opens into the working space, wherein furthermore at least one tube passes through the PAT channel and projects into the working space, and at the end of it is provided a device for measuring the temperature at the working space end, and which moreover comprises a rotary device for rotating the at least one tube, which is bent substantially at right angles at the end nearest the working space. Other suitable combinations of features of a centrifuge device provided are possible; for example, the tube may be introduced through the drive shaft into the working space and the catchment disk shaft may be used as a filling element, or the tube may be guided through a casing tube which is in turn arranged in the PAT channel. Moreover, the method comprises the steps of rotating the at least one tube, so that the end closest to the working space projects into the suspension, measuring a temperature T1, rotating the at least one tube so that an end closest to the working space does not project into the suspension, measuring a temperature T2 and the step of determining the moisture content of the suspension from temperatures T1 and T2.

The process described hereinbefore preferably serves to determine whether the suspension is sufficiently dry. In this way it is possible to determine when the drying process is complete. If the temperature in the suspension T1 is measured to be lower than a temperature outside the suspension T2, it can be assumed that this temperature difference is occurring as a result of the condensation taking place in the suspension. Using suitable formulae or experiential values compiled to make empirical formulae, it is thus possible to find a measurement of the moisture remaining in the suspension. If the temperature T1 gets close to the temperature T2 or if the temperatures are already identical, it can be assumed that no more condensation processes are taking place in the suspension and the product is dry. This prevents a damp product, further processing of which may not be possible, from being taken out.

A process according to the invention for taking samples from a centrifuge device comprises the step of preparing a centrifuge device according to the main claim of the present invention, which furthermore comprises a hollow catchment disk shaft with a PAT channel formed therein, one end of which opens into the working space, wherein at least one tube is accommodated through the PAT channel and projects into the working space, and at its working space end it is bent substantially at right angles and designed as a removal tube for removing a sample of suspension, and on which a funnel is mounted for receiving a sample of suspension, the centrifuge device further comprising a drying device which, by means of a vacuum which it creates, is capable of sucking the suspension sample through the at least one tube, and wherein moreover an outlet opening is provided through which the sample of suspension sucked out of the sample space by means of the at least one tube passes out. Furthermore, the process comprises the steps of rotating the at least one tube into the first position, rotating the at least one tube into the third position, so that suspension enters the funnel-shaped element, fixing the at least one tube in the third position, actuating the pump device so that the suspension contained in the funnelshaped element is sucked through the second tube, and finally the step of removing the sample of suspension at the outlet opening.

Thus, a sample of suspension can be removed from the working space while the machine is in operation, without having to open the working space, and examined outside the centrifuge device. In this way the state of the suspension can be monitored at every stage of the operation and the operating parameters can be optimally adjusted.

As a result of the technical features of the invention described hereinbefore, a variety of process analysis technologies can be used which make it possible to optimise the operation of the centrifuge device and the individual steps of centrifuging and drying. Moreover, it is possible to monitor the state of the suspension during operation by means of measuring devices and to regulate operation so that optimum process parameters are maintained throughout the entire operating time. As a result of the possibility of supervising product-specific parameters on-line and correcting them if necessary, which is made possible by the invention, there is a substantial improvement in the quality of the product and a considerable reduction in the quantities of product which are unsuitable for use.

Further features and embodiments of the invention will become apparent from the description and the attached drawings.

It should be understood that the features described hereinbefore and those which are to be explained hereinafter may used not only in the combination specified but in other combinations or on their own without departing from the scope of the present invention.

The invention is illustrated in the drawings by means of exemplifying embodiments and is hereinafter described in detail with reference to the drawings.

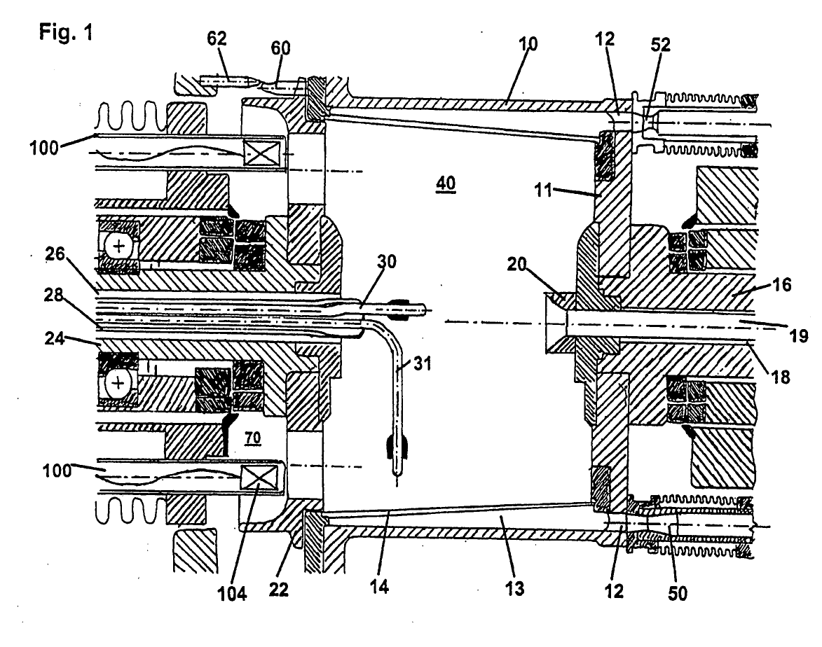

FIG. 1 shows a cross-sectional view of the working area with the filter surrounding it, the drum, the catchment disk in a closed position that tightly seals off the working space, and the adjoining components, in a preferred embodiment of the invention.

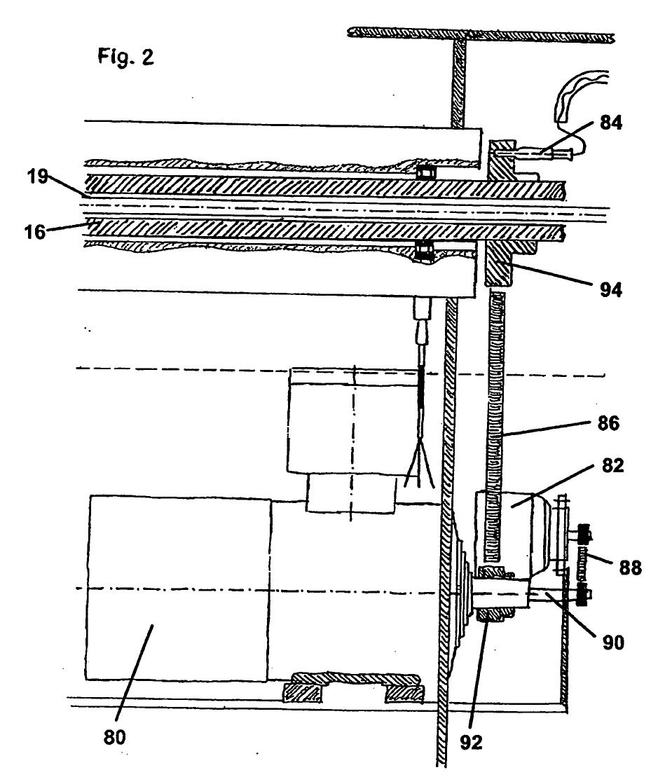

FIG. 2 shows the arrangement of the electric motor that drives the draft shaft, in a preferred embodiment of the invention.

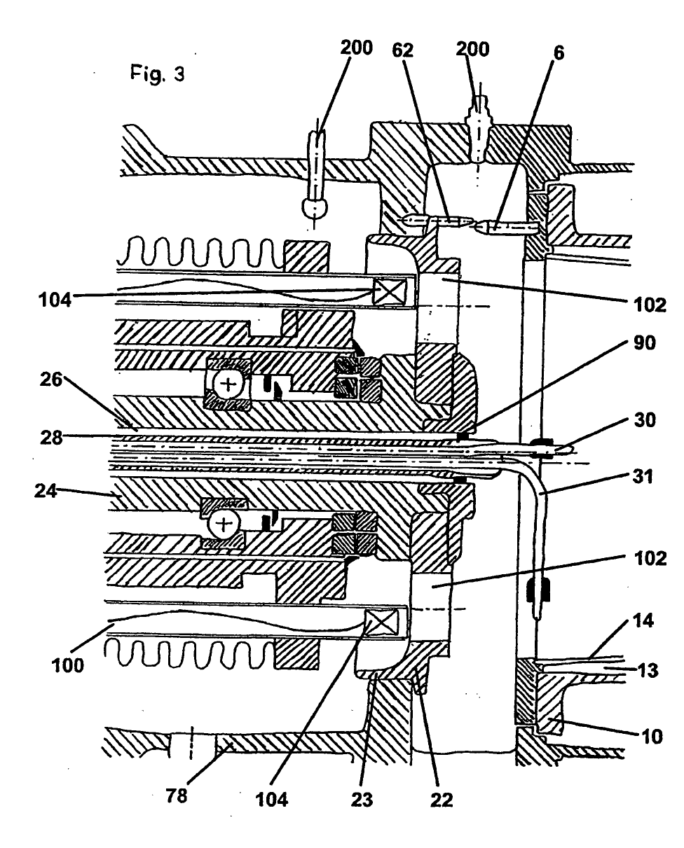

FIG. 3 shows an enlarged cross-sectional view of the catchment disk in an open position and the adjoining components in a preferred embodiment of the invention.

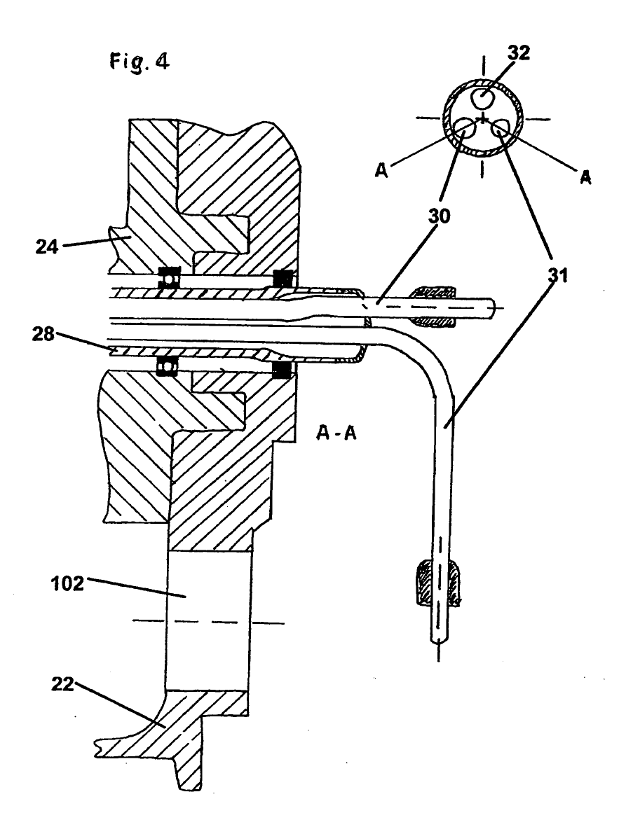

FIG. 4 shows an enlarged cross-sectional view of the end of the PAT channel at the working space end, with the tubes arranged in the PAT channel and a window provided in the catchment disk, in a preferred embodiment of the invention.

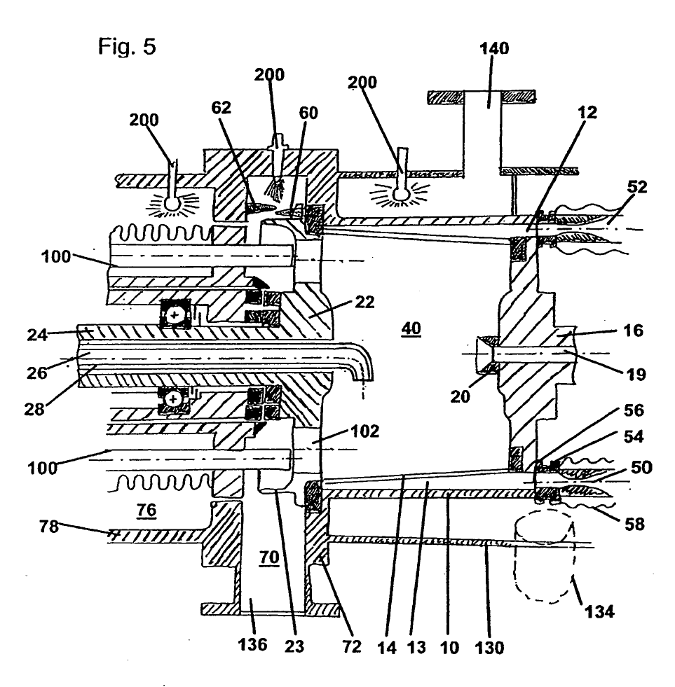

FIG. 5 shows the working space and the adjoining components in an embodiment of the invention, in which the catchment disk is in a closed position.

FIG. 1 shows the working space 40 with the filter 14 surrounding it. The filter 14 is a metal filter made of a rigid material and has a conical shape. Around the filter is mounted the drum 10 which comprises the openings 12 in the drum base. Between the filter 14 and the drum 10 is an annular space 13. One end face of the working space 40 is formed by the base of the drum 10 which is mounted on a drive shaft 16. The drive shaft 16 is hollow in construction and has inside it a drive shaft channel 18 which is used as a filling channel for the introduction of a suspension. Adjoining the drive shaft channel 18 is a funnel-shaped element 20. Opposite the drive shaft 16 is the catchment disk shaft 24 on which the catchment disk 22 is mounted. The catchment disk shaft 24 is of hollow construction and has a PAT channel 26 inside it. Guided in the PAT channel 26 is a casing tube 28 in which three tubes 30, 31, 32 are arranged. Of the three tubes, 30, 31, 32, two tubes 30, 31 are visible in FIG. 1.

When a suspension is introduced through the drive shaft channel 18, the suspension flows through the funnel-shaped element 20 and then enters the working space 40. The funnel-shaped element 20 prevents the suspension from dripping out of the drive shaft channel 18 and running along the base 11 of the drum towards the filter 14. By varying the fill pressure the suspension can be introduced into the working space 40 in a suitable arc.

During centrifuging, the liquid phase of the suspension goes through the filter 14 into the annular space 13 and flows out of it through an outflow 134. The solid phase of the suspension remains in the working space 40 and is uniformly distributed over the circumference of the filter, forming a layer which is referred to as the cake. After the centrifuging, this cake is broken off from the filter 14. This is done by blowing a high pressure pulse of fluid from the nozzles 50, 52 through the openings 12 in the base of the drum into the annular space 13. The suspension broken away is then gradually dried by the repeated blowing of a fluid into the annular chamber 13 and transported towards the catchment disk 22. The catchment disk 22 is in a closed state in FIG. 1, in which it engages in a follower pin 60 mounted on the drum. From this closed position the catchment disk is axially movable into an opened position in which it engages in a second pin 62. From the closed state the catchment disk 22 can be moved into the opened state, so that the dried suspension, which is also referred to as product, is transported by the continual emission of fluid pulses into the annular space 13, into an annular channel 70 from which it can be removed through a removal opening 136. The catchment disk and the adjoining components in the open position are also shown in FIG. 3.

FIG. 2 shows a section of the drive shaft 16 located at a distance from the drum, at which the drive shaft 16 is actuated by an asynchronous motor 80. The asynchronous motor 80 drives the secondary shaft 90. This is connected to the drive shaft 16 via a force-transmitting endless element 86, preferably a toothed belt, and drives it. The toothed belt 86 is connected to the shafts 90 and 16 by means of gear wheels 92 and 94. Furthermore, the secondary shaft 90 is connected to a sine/cosine transmitter 82 via another toothed belt 88. The sine/cosine transmitter 82 indicates the present position of the shafts 90, 16 to a movement control unit (not shown) which regulates the rotation of the drive shaft 16. The arrangement of the specific elements described above ensures high positional accuracy of the drive shaft 16. Moreover, the arrangement is such that the drive shaft 16 can be moved in both directions of rotation.

In addition, a zero position indicator 84 is provided which is able to establish a zero position of the drive shaft 16, on which the adjustment of the drive shaft 16 is based, by means of a counter element (not shown) provided in the gear wheel 94. Thus, a regulation can be carried out from each position of the drive shaft when the centrifuge device is switched on, if the drive shaft 16 is first of all automatically moved into a zero position in which the zero position indicator 84 and the counter element (not shown) are opposite each other. The regulation of the engine then begins from this position.

FIG. 3 shows the catchment disk 22 in an open position. In this position it is possible for product to pass from the working space 40 into the annular space 70. The axial movement of the catchment disk 22 is effected by an eccentrically mounted reciprocating piston (not shown). Obviously, any other suitable device for moving the catchment disk 22 would also be possible, such as a hydraulic device or a pneumatic device. The catchment disk 22 is mounted on the catchment disk shaft 24, which is hollow in construction. In this way the catchment disk shaft 24 forms a PAT channel 26 inside itself. Guided through the PAT channel 26 is a casing tube 28 which is mounted so as to be uncoupled from the rotation of the catchment disk shaft 24. This can be done by means of ball bearings, for example. Three tubes 30, 31, 32 are guided in the casing tube 28. FIG. 3 shows the tube 32. In the preferred embodiment an endoscope, i.e. a camera and a light source, is guided through the tube 30. The tube 30 projects into the working space 40. A device for measuring a temperature at the working space end of the tube 31 is passed through the tube 31. The tube 32, which is not shown in FIG. 3, projects nto the plane of observation. The tube is designed to take a sample of suspension. Provided on its end is a funnel which in the position of the tubes shown in the drawing, widens out conically downwards, i.e. in the direction of the tube 31.

Obviously, more or less than three tubes may be provided in the casing tube 28, or only one tube may be provided which is mounted directly in the PAT channel 26 without a casing tube 28. Similarly, devices other than those described above may be passed through the tubes. For example, a device may be provided for carrying out near infrared (NIR) spectroscopy, which is used to measure the moisture at the working space end of the corresponding tube. Of course, a light source may also be introduced into the working space separately from a camera, i.e. a separate tube may be provided for the light source and camera. This would allow a light source to be aligned independently of the camera. Theoretically, any kind of measuring device for measuring a desired state at the working space end of a tube is possible. Other kinds of optical monitoring devices, e.g. special cameras such as an infrared camera, for example, are also possible if the use of such devices is of value.

Mounted at the end of the casing tube remote from the working space is a rotary device (not shown). This can be used to rotate the casing tube independently of the catchment disk shaft. The tubes mounted in the casing tube rotate with it. Using the rotary device it is possible, for example, to rotate the tube 32, which projects into the plane of observation in the position shown in FIG. 3, through 180° into a position in which it projects out of the plane of observation. The funnel would then be moved through a suspension contained at the base of the working space 40 and pick up a sample of suspension. This could then be sucked up through a pumping device (not shown) at end of the tube 32 remote from the working space and used to carry out tests on the suspension or product. Similarly, the rotary device could be used to move the tube 31 with the device mounted thereon for measuring a temperature. The procedure connected with the rotation of the tubes are described in more detail below.

FIG. 4 is an enlarged view of the catchment disk 22. A cross-section through the casing tube 28 is also shown. The arrangement of the three tubes in the casing tube 28 is shown. Preferably, the tubes are arranged such that the centres form a triangle. Theoretically, however, the tubes could be arranged in any suitable manner. If more or less than three tubes were to be provided a different arrangement would necessarily be produced. The PAT channel 26 is sealed off from the working space by means of sealing elements 90. A seal is also provided at the end of the PAT channel 26 remote from the working space. To make it possible to work with toxic suspensions or products, the sealing elements are antiseptic double lip seals.

FIGS. 3 and 4 also show the windows 102 provided in the catchment disk 22 and made of a transparent material. In the preferred embodiment, three windows arranged at 120° intervals around the circumference are provided in the catchment disk 22, two of which can be seen in the plane of section in FIG. 3. Moreover, in the preferred embodiment, three window channels 100 are provided, two of which are also shown in the cross-sectional view in FIG. 3. The window channels 100 are also arranged at 120° intervals from one another. Optical monitoring devices 104 or devices for carrying out near infrared (NIR) spectroscopy 104 are provided in the window channels. The cake contained in the working space can be observed through the optical monitoring devices during centrifuging and drying. Using the means for carrying out NIR spectroscopy 104, the moisture content of the cake can be measured. In addition, a light source 104 may also be provided in the window channels. However, when a light source 104 is arranged in the window channels, harmful reflections are formed in the transparent material of the window 102. Therefore it is preferable to pass a light source through one of the tubes 30, 31, 32 to illuminate the working space. This avoids reflections in the window 102, and high quality images are obtained from the optical monitoring devices.

Theoretically, all the appropriate devices for measuring a desired state in the working space through the windows 102 can be provided in the window channels 100. Basically, care must be taken to ensure that the catchment disk with the windows 102 rotates during centrifuging, while the window channels 100 do not rotate. Thus, an image of the working space 40 is obtained only when a window 102 is in front of a window channel 100. Because of the high speed of the catchment disk during centrifuging, however, a very high number of pictures per second is obtained. The picture quality, however, increases as the number of windows increases, as in an arrangement with three windows 102 naturally there will be three times as many images per second as in the case of a catchment disk with only one window 102.

The arrangement of the three windows 102 and the three window channels 100 at 120° intervals gives the opportunity of surveying the entire working space during both drying and cleaning. A cleaning process is always required when, following the manufacture of one product, another product is to be made. Particularly when toxic products are used it is essential to clean the entire centrifuge device thoroughly. During the cleaning of the centrifuge device the catchment disk 22 is also in an open position. In a preferred embodiment it is then rotated such that the windows 102 are located in front of the window channels 100. Thus, with optical monitoring units in all three window channels 100, the entire working space can be monitored. In particular, any residues on the filter 14 can be detected.

FIG. 5 shows an alternative embodiment of the invention. In this, an arc-shaped member 120 is formed on the casing tube 28. An arc-shaped member of this kind can be used if all the tubes guided into the working space are to be bent at right angles. The arc-shaped member 120 then serves, among other things, to protect the tubes as far as possible from contamination by the suspension present in the working space 40. Apart from the arc-shaped member 120, the embodiment shown corresponds to a preferred embodiment. In FIG. 5 an intermediate space 132 can thus be seen between the drum 10 and a centrifuge housing 130, into which the liquid phase of the suspension escapes through the drum 10 during centrifuging. The liquid phase then runs out of the intermediate space 132 into an outflow 134. Also shown is the removal opening 136 by means of which the centrifuged and dried product which has been transported from the working space 40 into the annular channel 70 is removed. The removal opening 136, the outflow 134, the centrifuge housing 130 and the intermediate space 132 correspond to the respective components in the preferred embodiment.

The process according to the invention for measuring the moisture content of a suspension in a centrifuge drum is carried out as follows. After the suspension has been centrifuged and the cake has been broken away from the filter 14, the cake is in the lower part of the filter drum 10. The tube 31 containing a device for measuring a temperature at the working space end of the tube 31 is then rotated into the position shown in FIG. 1, i.e. so that the end of the tube nearest the working space points downwards into the lower part of the filter drum. The tip of the tube is then in the centrifuged moist suspension sludge. A temperature T1 is now measured. Then the tube 31 is rotated through 180° by means of the rotary device (not shown) to rotate the tubes, so that it points in the opposite direction to that shown in FIG. 1. A temperature T2 is now measured. The temperature T2 corresponds to the temperature in the working space 40. With a totally dry product the temperature T1 corresponds to the temperature T2. If the product is still damp, i.e. if there is still a moist suspension sludge present, the temperature T1 is lower than the temperature T2. Because of the condensation of the damp phase of the suspension that takes place during drying the temperature T1 in the suspension is lower. Thus, the difference in temperatures T1 and T2 indicates a moisture content in the suspension. The drying process should therefore be continued until the temperature T1 substantially corresponds to the temperature T2.

A method of taking samples from a centrifuge device is carried out as follows. The tubes 30, 31, 32 are rotated into the position shown in FIG. 1. The tube 32 (not shown) now projects into the cross-sectional plane shown in FIG. 1. The funnel formed on the tube 32 widens out downwards. By means of the rotary device (not shown) the tubes are manually rotated through 180°. Two stops (not shown) delimit the range of rotation of the tubes, so that a user cannot turn the tubes in the wrong direction. In the preferred embodiment the tubes can be secured in the position shown so as to prevent unwanted rotation of the tubes. Moreover, the tubes can be secured in a position rotated through 90° and a position rotated through 180°. The tubes are then rotated through 180°, while the funnel passes through the suspension contained in the lower part of the filter drum 14 and picks up some of the suspension. After the tubes have been rotated through 180° they are secured in this position. The tube 32 (not shown) now projects out of the cross-sectional plane shown in FIG. 1. By means of a pump device (not shown) the suspension sample contained in the funnel is now sucked through the tube 32 so that it can be removed through an outlet opening provided at the end of the tube 32 remote from the working space.

Around this outlet opening in the preferred embodiment is provided a so-called glove box in which there is a funnel into which the sample of suspension falls. The sample of suspension can now be analysed in the glove box. The use of a glove box also makes it possible to analyse toxic samples. Alternatively, the sample can be removed from the glove box through a lock and transported into a laboratory for analysis. In this way a suspension contained in the centrifuge device or a centrifuged dried end product can be removed and examined. This can be done without opening the working space, thus avoiding the entire quantity of suspension becoming unusable and incapable of further use if a check on the sample of suspension has a negative result.

The method described above can of course also be carried out automatically. Thus, it is possible for the rotary device to be rotated automatically by an electric motor controlled by a control unit. Thus, sampling may be carried out automatically and tied into the control of the centrifuge device as a whole. Alternatively it would be possible for example to initiate the taking of a sample by the press of a button.

Using the devices of process analysis technology described above it is possible to increase the quality of a product obtained in the centrifuge device substantially, as a result of the constant monitoring of the production process, and significantly reduce the amount of reject formed. This allows the centrifuge device to be operated in an economically advantageous manner.

1. Centrifuge device, comprising:
a drive shaft,
a drum attached to the drive shaft,
a filter arranged inside the drum and surrounding a working space, and
a catchment disk that forms one end face of the working space and is mounted on a catchment disk shaft, the catchment disk and the drum being movable relative to one another, with a fill element for introducing a suspension into the working space and with a centrifuge housing that surrounds the drum and the filter.

2. Centrifuge device according to claim 1, wherein the drive shaft is hollow in construction and has a drive shaft channel extending therein, in which is accommodated a drive shaft fill tube which is used as a fill element for the introduction of a suspension.

3. Centrifuge device according to claim 1, wherein the catchment disk shaft is hollow in construction and has a catchment disk shaft channel extending therein, in which is accommodated a catchment disk fill tube which is used as a fill element for the introduction of a suspension.

4. Centrifuge device according to claim 2, wherein a funnel-shaped element is mounted on an end of the drive shaft fill tube at the working space end.

5. Centrifuge device according to claim 4, wherein the funnel-shaped element is integrally formed with the drive shaft fill tube.

6. Centrifuge device according to claim 3, wherein a funnel-shaped element is mounted on an end of the catchment disk fill tube at the working space end.

7. Centrifuge device according to claim 6, wherein the funnel-shaped element is integrally formed with the catchment disk fill tube.

8. Centrifuge device according to claim 2, wherein a suspension that is to be centrifuged is conveyed by means of a pumping device, the pressure exerted on the suspension by the pumping device being variable.

9. Centrifuge device according to claim 1, wherein the drive shaft is driven by an electric asynchronous motor.

10. Centrifuge device according to claim 9, wherein the electric asynchronous motor is controlled by a movement control unit to which an transmitter unit sends the current position of the electric asynchronous motor, the drive shaft being rotatable in both directions of rotation by means of the electric asynchronous motor.

11. Centrifuge device according to claim 10, wherein the transmitter unit is a sine/cosine transmitter.

12. Centrifuge device according to claim 10, wherein the electric asynchronous motor has a secondary shaft extending through it which is connected, in each case via a force-transmitting endless element, to both the drive shaft and to the transmitter unit.

13. Centrifuge device according to claim 1, and further comprising a reciprocating piston eccentrically mounted on the catchment disk for axially moving said catchment disk.

14. Centrifuge device according to claim 1, wherein the catchment disk shaft is of hollow construction and comprises inside it a PAT channel, one end of which opens into the working space.

15. Centrifuge device according to claim 1, wherein the drive shaft is of hollow construction and comprises inside it a PAT channel, one end of which opens into the working space.

16. Centrifuge device according to claim 14, wherein at least one tube is passed through the PAT channel and projects into the working space.

17. Centrifuge device according to claim 16, wherein the at least one tube is surrounded by a casing tube.

18. Centrifuge device according to claim 16, wherein the at least one tube is mounted so as to be uncoupled from any rotation of the catchment disk and catchment disk shaft.

19. Centrifuge device according to claim 17, wherein the casing tube is mounted so as to be uncoupled from any rotation of the catchment disk and catchment disk shaft.

20. Centrifuge device according to claim 14, wherein in the at least one tube there is provided a device for carrying out near infrared (NIR) spectroscopy.

21. Centrifuge device according to claim 16, wherein a device for measuring the temperature at the working space end of the at least one tube is provided in the at least one tube.

22. Centrifuge device according to claim 16, wherein an optical monitoring unit for monitoring the working space is provided at the working space end of the at least one tube.

23. Centrifuge device according to claim 16, wherein a light source for illuminating the working space is provided at the working space end of the at least one tube.

24. Centrifuge device according to claim 16, wherein an endoscope is passed through the at least one tube into the working space.

25. Centrifuge device according to claim 16, wherein the at least one tube is constructed as a removal tube for removing a sample of suspension.

26. Centrifuge device according to claim 25, wherein an element for taking a sample of suspension is mounted at the working space end of the at least one tube.

27. Centrifuge device according to claim 26, wherein the element for taking a sample of suspension is preferably a funnel.

28. Centrifuge device according to claim 26, wherein a pump device is provided which is capable, by means of a vacuum produced by it, of sucking up the sample of suspension through the at least one tube.

29. Centrifuge device according to claim 28, wherein an outlet opening is provided through which the sample of suspension sucked out of the sample space through the at least one tube comes out.

30. Centrifuge device according to claim 28, wherein the pumping device is also capable of pumping a fluid which it has placed under pressure through the at least one tube.

31. Centrifuge device according to claim 29, wherein a sealed housing element is arranged around the outlet opening.

32. Centrifuge device according to claim 16, wherein an ultrasound cleaning device is arranged at the working space end of the at least one tube.

33. Centrifuge device according to claim 14, wherein the PAT channel is sealed off from the outer environment by means of a sealing element.

34. Centrifuge device according to claim 33, wherein the sealing element is an antiseptic double lip seal.

35. Centrifuge device according to claim 18, wherein a rotary device is provided for rotating the at least one tube.

36. Centrifuge device according to claim 35, wherein the rotary device is constructed so that the at least one tube can be fixed in at least one position.

37. Centrifuge device.according to claim 36, wherein the at least one tube is adapted to be fixed by means of the rotating device in a first position, in a second position which is rotated through 90° from the first position, and in a third position which is rotated through 90° from the second position and through 180° from the first position.

38. Centrifuge device according to claim 37, wherein the range of rotation of the rotary device is limited to 180° by two stops.

39. Centrifuge device according to claim 35, wherein the rotary device is to be operated manually.

40. Centrifuge device according to claim 35, having a motor for causing rotation of the rotary device.

41. Centrifuge device according to claim 40, wherein the motor is automatically controlled by a control unit.

42. Centrifuge device according to claim 16, wherein three tubes are provided.

43. Centrifuge device according to claim 42, wherein an endoscope with an optical monitoring unit and a light source is passed through a first tube, a second tube is designed to take a sample of suspension and comprises a funnel-shaped element at its working space end, and a third tube is provided with a device for measuring the temperature at its working space end.

44. Centrifuge device according to claim 43, wherein the three tubes are arranged in the cross-section of the casing tube such that the centres of the tube cross-sections form a triangle.

45. Centrifuge device according to claim 43, wherein the first tube runs straight, i.e. in the direction of the drive shaft opposite, into the working space, the second tube is bent substantially at right angles in the working space and the funnel-shaped element is arranged at the working space end so that when the three tubes are in the process of rotating, as a result of the rotary device, from the first position into the third position, the funnel-shaped element performs a semicircular movement in a lower half of the working space, and the third tube in the first position points substantially perpendicularly downwards.

46. Centrifuge device according to claim 1, wherein at least one window of a transparent material is provided in the catchment disk.

47. Centrifuge device according to claim 46, wherein at least one window channel is provided, one end of the window channel terminating in front of the at least one window.

48. Centrifuge device according to claim 47, wherein a device for carrying out near infrared (NIR) spectroscopy is provided in the at least one window channel.

49. Centrifuge device according to claim 46, wherein an optical monitoring device is provided in the at least one window channel.

50. Centrifuge device according to claim 47, wherein a light source is provided in the at least one window channel.

51. Centrifuge device according to claim 46, wherein three windows are provided which are arranged at 120° intervals around the circumference of the catchment disk.

52. Centrifuge device according to claim 51, wherein three window channels are provided which are arranged at 120° intervals around the circumference of the catchment disk.

53. Method of measuring the moisture content of a suspension in a centrifuge drum comprising the following steps:
preparing a centrifuge device having the features of claim 21 and a rotary device for rotating the at least one tube, which is bent substantially at right angles at its working space end,
rotating the at least one tube, so that its working space end Projects into the suspension,
measuring a temperature T1,
rotating the at least one tube so that its working space end does not project into the suspension,
measuring a temperature T2,
determining the moisture content of the suspension from temperatures T1 and T2.

54. Method of taking samples from a centrifuge device, comprising the following steps:
preparing a centrifuge device having the features of claim 29 and a rotary device for rotating the tube, which is bent substantially at right angles at its working space end,
rotating the at least one tube into the first position,
rotating the at least one tube into the third position, so that suspension enters the funnel-shaped element,
fixing the at least one tube in the third position,
actuating the pump device so that the suspension contained in the funnel-shaped element is sucked through the second tube,
removing the sample of suspension at the outlet opening.
